(19) United States
(12) Patent Application Publication
(10) Pub. No.: US 2014/0176697 A1
(43) Pub. Date: Jun. 26, 2014

(54) METHOD AND APPARATUS FOR DATA TELEMETRY

(71) Applicant: Abrado, Inc., Houston, TX (US)

(72) Inventors: Frank Cully Firmin, Lafayette, LA (US); Marshal Harris, Houston, TX (US)

(21) Appl. No.: 14/133,989

(22) Filed: Dec. 19, 2013

Related U.S. Application Data
(60) Provisional application No. 61/739,406, filed on Dec. 19, 2012.

(51) Int. Cl. E21B 47/12; H04N 7/18

(52) U.S. Cl. CPC E21B 47/12; H04N 7/18
USPC 348/85

(57) ABSTRACT

A bidirectional telemetry system for data transfer over relatively long distances such as, for example, within an oil or gas well. Data is transferred via cable such as a single conductor cable used for the transmission of various types of logging data including, but not limited to, video signals, pressure and temperature information. A video or other signal can be electronically converted into an amplified current modulated telemetry equivalent, transmitted along a cable having a varied impedance characteristics, and electronically converted back into a compliant voltage modulated composite video standard.

### BACKGROUND OF THE INVENTION

1. Field of the Invention

The present invention pertains to a method and apparatus for bidirectional telemetry or other data transfer over relatively long distances such as, for example, within an oil or gas well. More particularly, the present invention pertains to a method and apparatus for bidirectional data telemetry via a cable or other wire including, without limitation, single conductor cable used for the transmission of various types of logging data including, but not limited to, video, pressure and temperature information.

2. Brief Description of the Prior Art

Logging and other tools exist for obtaining downhole information from oil and/or gas wells. Such tools, which can be conveyed into and out of a well via a spoolable cable or so-called electric line, can include downhole camera and associated illumination systems for obtaining video and/or visual images within said wells. Typically, data obtained by such logging or other tools is conveyed from a downhole location in a well to surface equipment via a wire or other data transmission means included within said cable or electric line.

In the case of downhole video systems, video data is typically conveyed using a conventional 1-volt peak-to-peak composite video telemetry standard; however, said 1-volt peak-to-peak composite video telemetry standard suffers from a number of well-known and significant limitations. For example, existing downhole video systems that require cameras to be remotely deployed at substantial distances from supporting receivers are greatly limited by signal loss and/or degradation over long cables with many attenuating characteristics. As a result, optimization of cable designs, inline amplifiers, and/or signal repeaters are commonly used in order to extend the range of conventional video data transmission systems.

Certain applications, such as oil and gas well surveys and deep sea investigations, do not readily permit the use of inline electronics to boost signals over intermediate cable distances. Moreover, in addition to data transmission capabilities, such existing cable designs must also address the challenges of elevated pressures, temperatures, corrosive fluids, and the need to suspend heavy tensile loads before impedance optimization measure, if any, can be integrated. Wireless telemetry can be used in certain circumstances; however, wireless telemetry systems are typically faced with line of sight limitations, low frequency fluids propagation, subsurface saline reservoir shunting, and other adverse parameters.

Single-conductor cables without an insulated coaxial construction are commonly used in connection with conventional video data telemetry systems. Lengths up to 30,000 feet are common. Inherent ground loops and variations through wellbore logging intervals represent additional adversities that must be overcome. Said conventional composite video standard is designed for a single-conductor cable but requires impedance matching and ground loop control even for much shorter distances.

In an attempt to overcome certain of said limitations associated with analog composite video data transmission systems, system developers have resorted to a variety of digital telemetry schemes such as pulse-width-modulation and frequency-shift-keying derivatives. However, such digital video telemetry schemes require a high bandwidth capability, unavailable on electric line cables, to transmit the data densities needed to achieve a true streaming video performance. The analog characteristics of the low-bandwidth cables continue to plague performance of such digital systems, allowing only still camera performance specifications of approximately one frame per second.

Thus, there is a need for a video data telemetry system that will permit the transmission of video data over a conventional electric line cable including, without limitation, a single-conductor cable without an insulated coaxial construction. Such a video data telemetry system should permit transmission of video data over long distances, while overcoming wellbore conditions such as elevated pressures, temperatures, corrosive fluids, and heavy tensile loading.

### SUMMARY OF THE INVENTION

The data transfer system of the present invention comprises a novel hybrid analog/digital telemetry system that translates voltage-modulated composite video standard locally within a subsurface or subsea instrument into a current-modulated derivative with an inherent immunity to ground loop problems, circuit voltage drops, and wide impedance variations. A resilience to signal attenuation and distortion is also incorporated with added compensation/signal-reconstruction measures in the surface interface electronics.

Fundamentally, it is well established that capacitance opposes a change in voltage, while inductance opposes a change in current. The inherent inductance of a cable becomes the primary obstacle to high-speed signal modulation. Attenuation and distortion caused by inductive reactance contributors to the cable impedance present a lesser challenge than the capacitive effects on voltage modulated signal transmissions. Additionally, voltage varies with electrical current across resistance associated with connections, cable intervals, and connected instruments as a series of drops. The base level of current measures the same throughout a system circuit except where parallel paths exist.

Long distance cables have inherent characteristics of low-pass signal filters. To overcome the attenuation of high frequency signals carried on the voltage component due to this naturally occurring filter, the signal is imposed on the current component of the electrical system. Also, the composite video high-frequency color component is omitted from this telemetry scheme to support an optimum monochromatic signal quality and additional data of value.

Modulated current signal may be isolated from the generated voltage drops lagging in phase with the current by measuring the specific voltage drop across a precision resistor in a surface interface. The power DC baseline must be capacitively or inductively decoupled from a measurement input. Signal conditioning stages in the receiver are configured to process the small variations carried on the power baseline into a compliant 1-Volt peak to peak composite video signal for direct monitor supports, and internal digitization for USB serial transfer to computer. The depicted telemetry and modulation method is designed to maximize the data throughput of monochromatic video information within a 15.6 KHz bandwidth limit. The resulting data density supports 15 to 30 image frames per second compliant with video industry standards without challenging the bandwidth constraints of standard wireline cable designs in excess of 30,000 feet in length. Additionally, the inspection data sets for deep boreholes and other distant survey applications may include temperature and/or pressure measurements embedded within the described telemetry method without negating video streaming performance specifications. Other sensors of value may be incorporated in this up-scalable telemetry structure.

From the conventional adaptations of sensor resistance changes or resonating response to pulse-count output representations, pulses may be superimposed on the telemetry shoulders commonly referred to as “front porch” and “back porch”. With each sensor dedicated to either the leading or lagging portion of a single scan, combined with standard horizontal scan frequencies, only one pulse per shoulder superimposed supports raw resolution range counts from 0 to over 15,000 counts per second for each telemetry channel. This performance specification supports compliance with API pressure and temperature logging standards. The method of pulse superimposition permits inclusion in a separate dedicated instrument sharing the primary single conductor for power and data transmission. A precision timing circuit detects the current-modulated video sync pattern (or pulse) and transmits a pulse current within the square shoulder duration with spec attributes that propagate long cable distances with a minimum of attenuation. Shoulder disruption is minimal and within levels that permit a continued video sync threshold discrimination and steady scan rate. Given only 1.5 μs porch duration, a single pulse of opposite transient polarity is best to maintain sync stability. A 2.5 μs reference burst shoulder following the sync pulse preceding the back porch transition is a more fault tolerant utilization. The most stable embodiment interlaces extra sensor data between horizontal scan sub-cycles.

It is to be observed that the long distance video telemetry system of the present invention can be used in connection with many different applications including, without limitation, the downhole camera and lighting system disclosed in U.S. Non-Provisional patent application Ser. No. 14/043,198 filed Oct. 1, 2013, which is incorporated herein by reference for all purposes.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side schematic view of a preferred embodiment of a well site setup involving a downhole camera, derrick and electric line cable unit.

FIG. 2 depicts a side schematic view of a preferred embodiment telemetry path of the present invention through an electronic system of a well site.

FIG. 3 is a block diagram depicting the flow of data from downhole sensors to surface monitoring in accordance with a preferred embodiment of the present invention.

### DETAILED DESCRIPTION OF A PREFERRED EMBODIMENT

The present invention comprises a method for transmission and receipt of visual, numerical and various data forms to and from surface and downhole environments. By way of illustration, but not limitation, the present invention comprises a telemetry system for downhole inspection of wellbores including, without limitation, oil and/or gas wells. The method of the present invention reduces and/or eliminates the problems observed with conventional downhole camera data transfer telemetry systems.

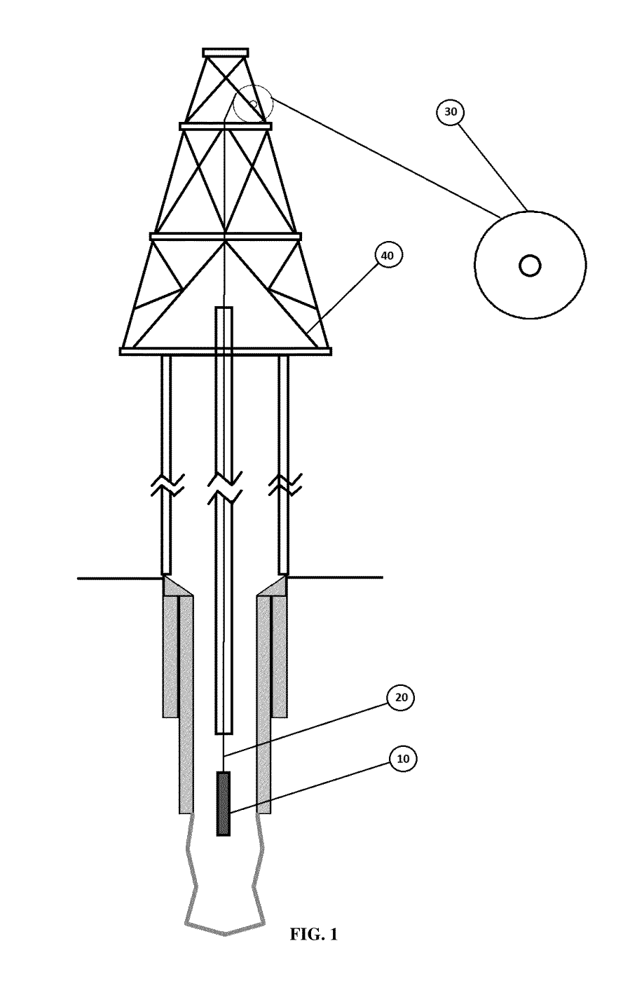

FIG. 1 depicts a side schematic view of a preferred embodiment of a well site setup configuration involving a downhole camera 10, derrick 40 and electric line cable unit 30. A downhole camera tool 10, equipped with various other sensors, is deployed and suspended on electric line cable 20 within a wellbore. This electric line cable 20 consists of a single-conductor used to power the tool while simultaneously transmitting data to surface equipment. Although additional embodiments can be envisioned, in the embodiment depicted in the appended drawings said telemetry is adapted to be used with a tool conveyed into and out of a wellbore via conventional electric line.

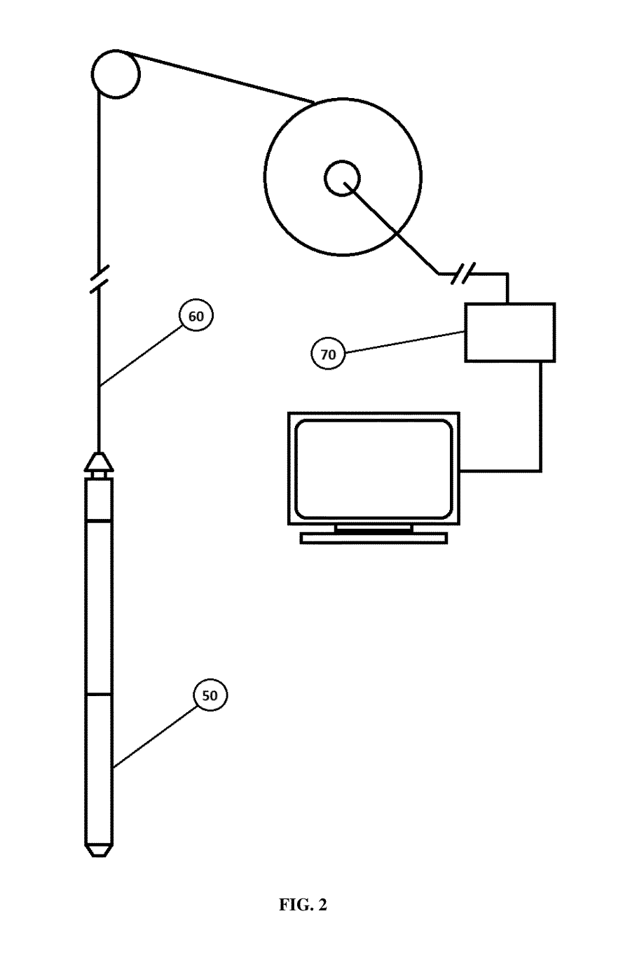

FIG. 2 is a side schematic view depicting a preferred embodiment of the telemetry path of the present invention through an electronic system of a well site. Visual and sensory data is captured from the tool 50 powered from surface equipment 70 through electric line cable 60. Simultaneous to receiving power from surface equipment, data is transmitted from the downhole tool assembly to surface equipment via said electric line cable.

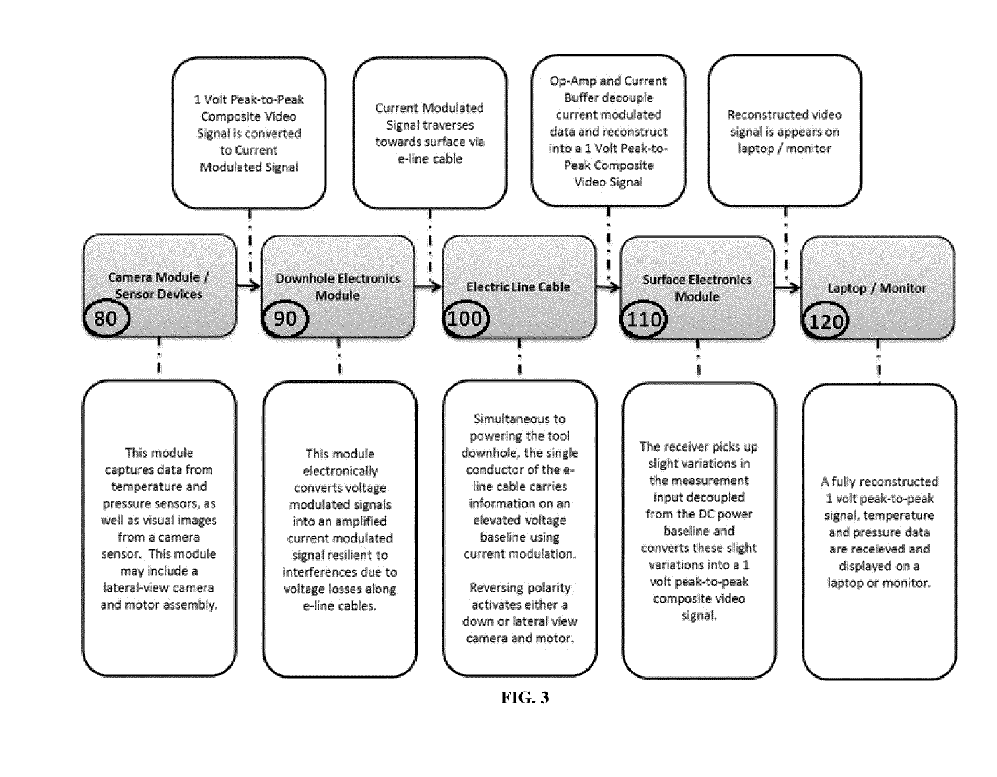

FIG. 3 is a block diagram depicting the flow of data from downhole sensors 80 to surface monitoring 120 and the modulations through which the signal converts between the downhole tool and surface electronics. Visual data is acquired from a camera sensor 80 in a 1 volt peak-to-peak format. Typically, a composite video signal has a single wave duration of 63.5 μs (the active visual data portion of this wave is 52 μs duration). A scan line is made up of numerous waves with a beginning marked by a distinctive sync pulse to mark a new scan line. Sensor data may be superimposed within the front or back “porches” of a wave within a scan line without subtraction from or degradation to the active visual data portion of the wave.

Derivatives of the above-described portion of this invention may include waveforms of longer duration to lengthen the front and back porches. This would allow for easier detection of the sync pulse as well as easier imposition of data onto the wave form. A longer duration waveform derivative would decrease the total number of frames per second seen on surface monitoring equipment.

Still referring to FIG. 3, voltage modulated data (the 1 volt peak-to-peak signal) captured from the downhole tool 80 is converted into a current modulated signal within the downhole electronics module 90. Unlike current measurements, voltage is affected by variable cable resistances along the length of the cable, imposed during well site operations and subject to wellbore environment. Therefore, a current modulated signal as described above maintains an inherent immunity to signal losses due to changes in cable resistance.

Still referring to FIG. 3, a specific range of power must reach the downhole tool in order to power the tool. With variable resistances along the cable apparent, an adjustable power source at surface 120 is needed to power the tool 80 and 90. An adjustable power source at surface 120 may be used to increase, decrease or supply an opposite polarity power feed to the tool. Switching the polarity of the power supplied dictates which camera view (down or lateral) is activated within the downhole tool 80. It is important to note that these changes in voltage magnitude and polarity are independent of the sum of currents within the system and retain intricate data found within the current modulated signal imperative to the telemetry. It is also important to note that the current modulated signal must ‘ride’ a higher voltage baseline than typical television signals.

Still referring to FIG. 3, the current modulated signal traverses the electric line cable 100 until reaching the surface electronics module 110. In this module 110, the current modulated signal is reconstructed into a 1 volt peak-to-peak composite video signal. In case of the derivative where sensor data has been imposed upon the front and/or back “porches” of the video signal, precision resistors and transistors read and transmit this data. In case of the derivative where the current modulated signal wave has been elongated, the 1 volt peak-to-peak composite video signal will be shortened to its original (universally typical) duration or a derivative universally accepted by typical monitors and television sets.

The present invention comprises a voltage modulated composite video standard converted electronically into an amplified current modulated telemetry equivalent capable of traversing greater cable distances of varied impedance characteristics. Such current modulated telemetry equivalent is converted and reconstructed at a receiving cable end electronically back into compliant voltage modulated composite video standard supported by conventional monitoring and recording equipment. The current modulated data signal can ride an elevated voltage baseline of either polarity providing power to a video camera and supplemental instruments on a single conductor cable of extended length in either an insulated coaxial or bare armor construction.

With the present invention, at least one additional (secondary) camera and/or supplemental instrument(s) can be configured for an alternative viewing capability using said single power and data conductor and operated selectively by applying opposite polarity of power to the cable end opposite said instruments. Said supplemental instruments can be combined and connected together for simultaneous operation multiplexed with a secondary video camera collectively powered as a group by polarity opposite that of the primary camera and instrument set.

The present invention can further use asynchronous video camera output as a synchronization source for multiplexing data sets of additional sensors on a single conductor utilized for both data and instrument power. Additionally, a composite video standard sync pattern can be isolated locally to a video camera and replaced by a distinct current sinking pulse of negative polarity of greater amplitude than a recombined data portion of signal to better synchronize frames propagated over greater cable distances of variable impedance.

The distinct synchronization pulse of the present invention more precisely supports time division multiplexing of additional sensors such as temperature and pressure superimposed singularly as a pulse either present or absent on either the front or back porch portions of each horizontal scan sub-cycle to support a raw measurement range of 0 to over 15 thousand counts per second. Further, the distinct synchronization pulse supports time division multiplexing of additional sensors interlaced with video horizontal scan sub-cycles while effectively maintaining a compliant streaming video performance specification or quality of reduced scan resolution.

The present invention can permit light emitting diode (“LED”) or other light source intensity control by way of surface voltage adjustment without impeding the function of the described telemetry system. Further, the present invention can support a motor on/off control to rotate said camera, and/or motor speed control, by way of surface voltage adjustment without impeding the function of the described telemetry.

The voltage modulated composite video standard of the present invention can comprise an elongated waveform before being converted electronically into an amplified current modulated telemetry which traverses greater cable distances of varied impedance characteristics, is converted and is reconstructed at the receiving cable end electronically back into the compliant voltage modulated composite video standard to support conventional monitoring and recording equipment.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method for data telemetry comprising:
a) converting a video signal electronically into an amplified current modulated telemetry equivalent;
b) traversing a cable having a length and varied impedance characteristics with said current modulated telemetry equivalent; and
c) converting said current modulated telemetry equivalent electronically into a compliant voltage modulated composite video standard.
